(19) United States
(12) Patent Application Publication
(10) Pub. No.: US 2015/0268512 A1
(43) Pub. Date: Sep. 24, 2015

(54) LIQUID CRYSTAL OPTICAL ELEMENT AND IMAGE APPARATUS

(71) Applicant: KABUSHIKI KAISHA TOSHIBA, Minato-ku (JP)

(72) Inventors: Honam KWON, Kawasaki (JP); Yuko KIZU, Yokohama (JP); Yukio KIZAKI, Kawasaki (JP); Machiko ITO, Yokohama (JP); Kazuhiro SUZUKI, Tokyo (JP); Hideyuki FUNAKI, Tokyo (JP)

(73) Assignee: KABUSHIKI KAISHA TOSHIBA, Minato-ku (JP)

(21) Appl. No.: 14/640,523

(22) Filed: Mar. 6, 2015

(30) Foreign Application Priority Data
Mar. 19, 2014 (JP) 2014-055860

(51) Int. Cl. G02F 1/1335; H04N 5/225; G02B 13/00; G02F 1/1337; G02F 1/1339

(52) U.S. Cl. CPC G02F 1/133526; G02F 1/1337; G02F 1/1339; G02F 1/133514; G02B 13/0015; H04N 5/2254

(57) ABSTRACT

A liquid crystal optical element includes a first electrode, a second electrode, a first alignment film, a second alignment film, spacers and a liquid crystal layer. The first electrode includes a plurality of lens parts.

The second electrode opposes the first electrode. The first alignment film is formed between the first electrode and the second electrode. The second alignment film is formed between the first alignment film and the second electrode. The spacers are provided between the first electrode and the second electrode. The spacers are regularly arranged, each at edges of the lens parts. The liquid crystal layer is provided between the first alignment film and the second alignment film.

### CROSS-REFERENCE TO RELATED APPLICATIONS

This application is based upon and claims the benefit of priority from the Japanese Patent Application No. 2014-055860, filed Mar. 19, 2014, the entire contents of which are incorporated herein by reference.

### FIELD

Embodiments described herein relate to a liquid crystal optical element and an image apparatus.

### BACKGROUND

Techniques of determining the distance to an object in the depth direction are known in the art. A distance-measuring technique uses a reference light beam. Another distance-measuring technique uses several cameras. In recent years, the demand has increased for imaging apparatuses for consumer use, which are relatively simple in configuration and relatively inexpensive, and yet able to acquire distance data.

A compound-eye imaging apparatus having many pair of lenses has been proposed as an imaging apparatus that can detect various parallaxes and can prevent deterioration in resolution. The compound-eye imaging apparatus has a plurality of imaging lenses and a plurality of optical systems. Each optical system is used as re-imaging optical system and is arranged between the imaging lens and an imaging element. The optical systems are, for example, micro-lenses regularly arranged in, for example, a flat plane, forming a micro-lens array. At the side of outputs of the micro-lenses, pixel blocks are provided to receive the images defined by the light fluxes emitted from the respective micro-lenses. Each pixel blocks includes a plurality of pixels. The pixels are provided on the imaging element. The image focused by the imaging lens is focused again by a micro-lens at one of the pixel blocks associated with the micro-lens. The image formed again is a parallax image shifted by the parallax specific to the position the micro-lens assumes. The parallax images obtained by the micro-lenses are processed, estimating the distance to the object by using the principle of trigonometrical survey. Further, the parallax images can be coupled to one another, thereby reconstructing a two-dimensional image of the object.

In most cases, a two-dimensional reconstructed image has a lower resolution than a two-dimensional image generated by an imaging apparatus that does not have a plurality of optical systems. This is why the imaging apparatus disclosed in Jpn. Pat. Appln. KOKAI Publication No. 2008-167395 can operate in two imaging modes, by using or not using a plurality of optical systems. In the first imaging mode, the imaging apparatus can detect the distance to the object. In the second imaging mode, the imaging apparatus can provide a two-dimensional image of high resolution. That is, liquid-crystal optical elements are used as optical systems in the imaging apparatus disclosed in Jpn. Pat. Appln. KOKAI Publication No. 2008-167395. A voltage is applied to the liquid-crystal optical elements, setting them in a focused state, or no voltage is applied to the liquid-crystal optical elements, setting them in a non-focused state.

Two types of liquid-crystal optical elements are known in the art. One is the framework type, and the other is the gradient index (GRIN) type. The framework type comprises two lens-shaped electrodes and a liquid crystal layer sealed between these electrodes. Between the lens-shaped electrodes, a voltage is applied, changing the refractive index the liquid crystal has with respect to the lens-shaped electrodes, thereby switching the liquid-crystal optical element to the focused state or the non-focused state. On the other hand, the GRIN type comprises a linear electrode and a planer electrode arranged to be parallel to the linear electrode, and a liquid crystal layer sealed between these electrodes. To the linear electrode, a voltage is applied, changing the refractive index distribution in the liquid crystal sealed between the linear electrode and planer electrode, ultimately switching the liquid-crystal optical element to the focused state or the non-focused state.

To maintain the characteristics of the liquid-crystal optical element, the liquid-crystal layer gap must have a desirable value. The liquid-crystal optical element is preferably as thin as possible, because in recent years it is demanded that the micro-lens array be thin. Therefore, the lid for sealing the liquid crystal layer is made thinner and thinner. The thinner the lid, the more likely it will warp. If the lid warps, the liquid-crystal layer gap will inevitably deviate from the desired value. A method of keeping the liquid-crystal layer gap at the desired value is known, in which micro-beads are mixed in the liquid crystal layer. If this method is used, however, the liquid crystal layer cannot perform its function at the positions of the micro-beads. If used as micro-lenses, the liquid-crystal optical element functions but in a very small area. This is inevitably because the micro-lenses are dispersed uniformly (at random) in the liquid crystal layer in most cases. That is, the micro-beads greatly impair the function of the liquid crystal layer.

### BRIEF DESCRIPTION OF THE DRAWINGS

FIG. 1 is a plane view of an imaging apparatus having a liquid crystal optical element according to an embodiment;

FIG. 2 is a cross-sectional view taken along line 2-2 shown in FIG. 1;

FIG. 3 is a plane view of an imaging apparatus having a liquid crystal optical element according to modification 1;

FIG. 4 is a cross-sectional view taken along line 4-4 shown in FIG. 3;

FIG. 5 is a plane view of an imaging apparatus having a liquid crystal optical element according to modification 2;

FIG. 6 is a cross-sectional view taken along line 6-6 shown in FIG. 5;

FIG. 7 is a plane view of an imaging apparatus having a liquid crystal optical element according to modification 3;

FIG. 8 is a cross-sectional view taken along line 8-8 shown in FIG. 7; and

FIG. 9 is a plane view of an imaging apparatus having a liquid crystal optical element according to modification 4.

### DETAILED DESCRIPTION

According to one embodiment, a liquid crystal optical element includes a first electrode, a second electrode, a first alignment film, a second alignment film, spacers and a liquid crystal layer. The first electrode includes a plurality of lens parts. The second electrode opposes the first electrode. The first alignment film is formed between the first electrode and the second electrode. The second alignment film is formed between the first alignment film and the second electrode. The spacers are provided between the first electrode and the second electrode. The spacers are regularly arranged, each at edges of the lens parts. The liquid crystal layer is provided between the first alignment film and the second alignment film.

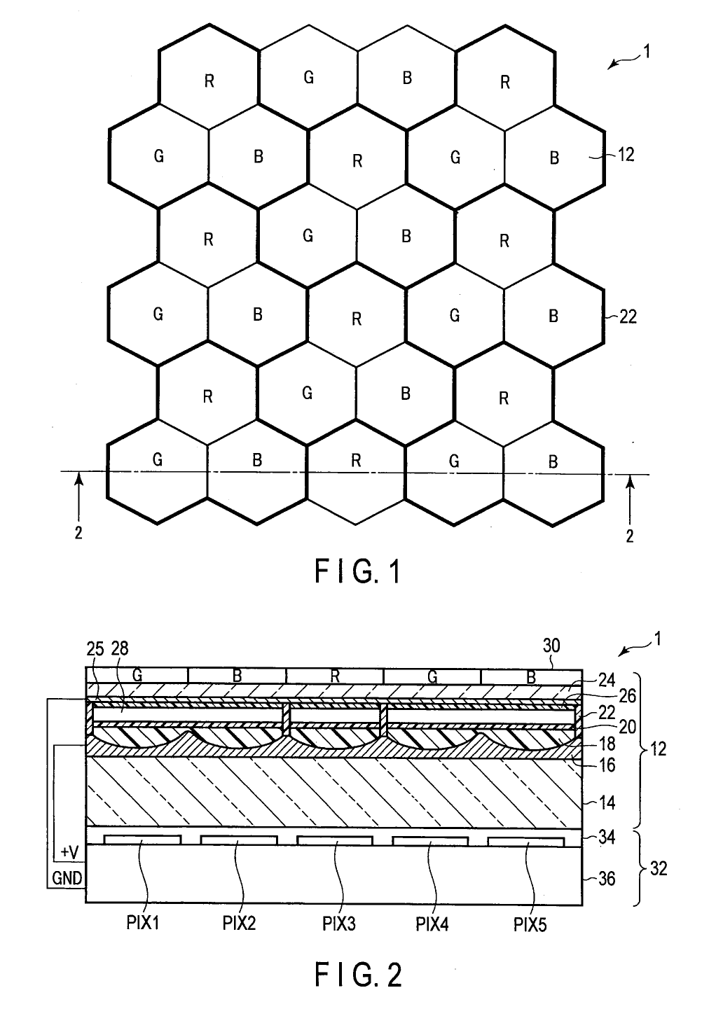

An embodiment will be described with reference to the drawings. FIG. 1 is a plane view of an imaging apparatus 1 that has a liquid crystal optical element according to an embodiment. FIG. 2 is a cross-sectional view taken along line 2-2 shown in FIG. 1. In FIG. 1, R, G and B indicate the colors of the color filters associated with the micro-lenses that constitute the liquid crystal optical element. More precisely, R, G and B indicate red, green, and blue, respectively.

The imaging apparatus 1 has a liquid crystal element 12 and an image unit 32. The liquid crystal element 12 is laid on the image unit 32. The image apparatus 1 shown in FIG. 1 is, for example, an imaging apparatus. The liquid crystal element 12 and the image unit 32 overlap each other so that the light applied to the liquid crystal element 12 may be focused at the image unit 32 when the liquid crystal element 12 functions as a lens.

The liquid crystal element 12 has a first electrode, a second electrode, a first alignment film, a second alignment film, spacers, and a liquid crystal layer. The first electrode includes a plurality of lens parts. The second electrode opposes the first electrode. The first alignment film is formed between the first electrode and the second electrode. The second alignment film is formed between the first alignment film and the second electrode. The spacers are formed between the first electrode and the second electrode, and are regularly arranged, each surrounding the circumference of one lens part. The liquid crystal layer is provided between the first alignment film and the second alignment film.

The liquid crystal element 12 may further have a color filter. In this case, the second electrode is interposed between the second alignment film and the color filter.

The color filter has a first element, a second element and a third element. The first, second element and third elements oppose, respectively the lens parts arranged on one major surface.

The spacers surrounding the circumferences of the first element, second element and third element are preferably revolution-symmetric in respect to one point, if they are projected to the major surface. The first element, second element and third element are preferably revolution-symmetric in respect to one point, if they are projected to the major surface.

The spacers may be shaped like at least one of H-shape, Y-shape, V-shape and cross-shape.

The liquid crystal element 12 is interposed between the first electrode and the first alignment film, and may have a buried layer filling the recess made in the first electrode. The spacers and the buried layer may be made of the same material.

The image apparatus 1 thus comprises such a liquid crystal element as described above, and an image unit opposing the liquid crystal element. The image unit has a plurality of pixel blocks that oppose the lens parts, respectively.

As shown in FIG. 1, the liquid crystal element 12 has micro-lenses shaped like a hexagon and arranged in alignment with the pixel blocks of the image unit 32. The liquid crystal element 12 assumes a non-lens state or a lens state, depending on the state of the liquid crystal layer. In the non-lens state, the liquid crystal element 12 outputs the light applied to it, without collecting the light. In the lens state, the liquid crystal element 12 collects and outputs the light applied to it. The micro-lenses shown in FIG. 1 are shaped like a hexagon. Instead, the micro-lenses may be shaped like a disc, square, or have another shape.

Each micro-lens of the liquid crystal element 12 has a first substrate 14, a first electrode 16, a first alignment film 20, a spacer 22, a second substrate 24, a second electrode 25, a second alignment film 26, and a liquid crystal layer 28. The liquid crystal element 12 may further have a buried layer 18 and a color filter 30. In this embodiment, the liquid crystal element 12 has a buried layer 18 and a color filter 30.

The first substrate 14 is a flat substrate transparent to light. The first substrate 14 is made of, for example, the deposited silicon dioxide or transparent resin. The first substrate 14 has a major surface on which the first electrode 16 is formed. The first electrode 16 is made of a material transparent to light, such as indium tin oxide (ITO). The first electrode 16 is shaped like a hexagon, as viewed from the front of the liquid crystal element 12. Further, the first electrode 16 is delta-arranged in alignment with the color filter 30. The first electrode 16 has a cross section shaped like a lens. More specifically, the first electrodes 16 are shaped like a plano-concave lens or like a plano-convex lens. In the embodiment of FIG. 2, each first electrode 16 is shaped like a plano-concave lens. The first electrodes 16 are connected to the driver 36 provided in the image unit 32. The driver 36 applies a preset voltage V to the first electrodes 16.

The buried layer 18 is made of, for example, a resin that is transparent to light, and is buried in the recess made in the first electrode 16. The surface of the buried layer 18 which opposes the liquid crystal layer 28 has depressions and projections smaller than those of the first electrode 16. This surface of the buried layer 18 may be flat, for example. In this case, the buried layer 18 makes the first electrode 16 flat. Note that the refractive index of the first buried layer 18 is equal to that of the first electrode 16 and that of the liquid crystal layer 28.

The first alignment film 20 is formed on the first buried layer 18, and is an alignment film for achieving initial alignment of the molecules of the liquid crystal layer 28. The first alignment film 20 aligns the molecules of the liquid crystal layer 28 (mainly in that part facing the first substrate 14) in, for example, the horizontal direction. The first alignment film 20 has been subjected to, for example, a rubbing process.

The spacers 22 are regularly arranged, each aligned with the boundary of one first electrode 16, i.e., boundary of the micro-lens, and contacting the second electrode 25. The spacers 22 are made of, for example, the same material as the first buried layer 18. Each spacer 22 has a shape following the shape of the boundary of the micro-lens, as viewed from the major surface of the first substrate 14, on which the first electrode 16 is provided. This major surface of the first substrate 14 is parallel to the major surface of the color filter. In FIG. 2, the spacer 22 is shown though it is actually not seen. As shown in FIG. 1, the spacer 22 is shaped like a V-shape, extending along the boundary of three delta-arranged micro-lenses. The three micro-lenses are associated with R, G and B color filter elements, respectively. Six V-shaped spacers 22 are coupled to one another, forming a spacer unit that extends along the boundary of the three delta-arranged micro-lenses (associated with the R, G and B pixel blocks provided in the image unit 32). In other words, six spacers 22 are arranged to surround three micro-lenses that are delta-arranged.

The second substrate 24 is a flat substrate transparent to light, and functions as a lid for the liquid crystal element 12. The second substrate 24 is made of, for example, the deposited silicon dioxide or transparent resin. The second substrate 24 has a major surface that opposes the major surface of the first substrate 14. The second electrode 25 is made of a material transparent to light, such as indium tin oxide (ITO), and is a planer electrode film provided on the major surface of the second substrate 24. As shown in FIG. 2, the second electrode 25 is maintained at the ground potential GND. In this embodiment, the second electrode 25 is a continuous member, but is not limited to a continuous member in the embodiment.

The second alignment film 26 is formed on the major surface of the second substrate 24, and is an alignment film for achieving initial alignment of the molecules of the liquid crystal layer 28 (mainly in that part facing the second substrate 24) in, for example, the horizontal direction. The second alignment film 26 has been subjected to, for example, a rubbing process.

The liquid crystal layer 28 is interposed between the first substrate 14 and the second substrate 24. As a voltage is applied to the liquid crystal layer 28, the liquid crystal molecules are changed in alignment in the liquid crystal layer 28. The liquid crystal layer 28 is made of, for example, nematic liquid crystal.

The color filter 30 is, for example, an absorption filter of the primary color system. Any absorption filter of the primary color system comprises filter elements R, G and B, which are arranged in alignment with the pixel blocks of the image unit 32. The filter element R allows passage of red light and absorbs green light and blue light. The filter element G allows passage of green light and absorbs red light and green light. The filter element B allows passage of blue light and absorbs red light and green light. In the embodiment of FIG. 1, the filter elements are delta-arranged. The color filter 30 need not be an absorption filter of the primary color system. Instead, it may be a complementary-color filter.

The imaging unit 32 has a pixel unit 34 and a driver 36. The pixel unit 34 comprises pixel blocks (five PIX1 to PIX5 shown in FIG. 2), which are arranged, forming an array. As described above, the pixel blocks PIX1 to PIX5 are associated with the filter elements of the color filter 30, respectively. Each pixel block is composed of a plurality of pixels. Assume that the image apparatus 1 is an imaging apparatus. Then, each pixel is, for example, a photodiode that converts light coming from an object to a signal charge proportional to the intensity of the light. The driver 36 has a drive circuit and a pixel-signal processing circuit. The drive circuit 36 is configured to drive the pixels. The pixel signal processing circuit is configured to read the signal charges accumulated in the pixels and process the signals charges. The drive circuit further controls the charge accumulation in each pixel of an imaging element and reads the signal charge accumulated in each pixel as an image signal that is, for example, a voltage signal. The pixel-signal processing circuit performs various processes, such as a process of adjusting the gain of the image signal and a process of converting the image signal read as an analog signal, to a digital signal.

As specified above, the liquid crystal element 12 is so configured that the alignment of the liquid crystal molecules is changed in the liquid crystal layer 28, as a voltage is applied between the first electrode 16 and the second electrode 25. If no voltage is applied to the first electrode 16, the alignment film controls the liquid crystal molecules, uniformly aligning them in the liquid crystal layer 28. As a result, the refractive index is uniform in the entire liquid crystal layer 28. Since the liquid crystal layer 28, first electrode 16 and first buried layer 18 have the same refractive index, the light coming from the object to the liquid crystal element 12 is applied to each pixel. The image the image unit 32 forms at this point is an image of high resolution.

If a voltage is applied to the first electrode 16, the first electrode 16 and second electrode 25 generate an electric field. The electric field aligns the liquid crystal molecules in the liquid crystal layer 28. In this embodiment, the first electrode 16 can be regarded as almost a point electrode. The electric field generated by the first electrode 16 and second electrode 25 is nearly semispherical, with its apex located at a convex part of the first electrode 16 as seen in the cross-sectional view of FIG. 2. If the liquid crystal layer 28 has positive dielectric anisotropy, the liquid crystal molecules of the liquid crystal layer 28 will have their longer axes aligned along the semispherical electric field. The light coming from the object to the liquid crystal element 12 is therefore focused at the liquid crystal element 12. The image formed by the image unit 32 is composed of a plurality of images having parallax and thus shifted from one another. From the image shift, the distance to the object can be determined.

In the embodiment, the spacers 22 are regularly arranged, each aligned with the boundary of one first electrode 16, i.e., boundary of the micro-lens, and contacting the second electrode 25. This more controls the warping of the second substrate 24 than in the case where a spacer is arranged only at the periphery of the liquid crystal element 12. This maintains a constant gap of the liquid crystal layer 28. The boundary of each micro-lens, at which a spacer 22 is arranged, defines a dead space. The part of the liquid crystal in the dead space does not function as liquid crystal, but a function as a micro-lens of the liquid crystal element 12 is not affected. Therefore, the spacer 22 so arranged does not degrade the characteristics of the liquid crystal element 12. Further, since the boundary of each micro-lens defines a dead space, a degree of positioning tolerance is available for the pixel blocks (i.e., pixels). Moreover, the spacers 22 can be regarded as optically transparent if they have the same refractive index as that of the liquid crystal layer 28.

As shown in FIG. 1, the spacers 22 are arranged, each surrounding a micro-lens. Therefore, the spacers 22 may be arranged densely in the liquid crystal layer 28. Since a gap of the liquid crystal element 12 is maintained, the strength of the liquid crystal element 12 may increase.

The three delta-arranged pixel blocks (i.e., R pixel block, G pixel block and B pixel block) and the spacers surrounding these pixel blocks will be described in detail. Assume that one pixel block and the spacers 22 contacting the pixel block constitute a set. The set includes four spacers 22 as shown in FIG. 1. Thus, three pixel blocks and the spacers 22 surrounding these pixel blocks constitute three sets. If the three sets are projected to a plane parallel to one major surface of the first substrate 14, they will be revolution-symmetric to one another, spaced from one another by 60° around one point at which they contact. Thus, the three sets are symmetric to one another.

The three image signals generated in the three pixel blocks of each set, respectively, are processed, generating three images (i.e., R image, G image and B image). The three images are synthesized, generating a color image. The color image may contain much noise if the pixel blocks differ in light-receiving area. The image signal generated by the pixel block having a small light-receiving area must be intensified to match the image signals generated by the other pixel blocks. If the image signal is intensified, however, the noise it contains will be inevitably amplified. Consequently, the image signal may contain much noise in some cases.

In this embodiment, the three pixel blocks of each set have the same light-receiving area, and can therefore generate a color image containing only a little noise. That is, the pixel blocks of each set do not differ in terms of characteristics in the liquid crystal element 12.

In this embodiment, the liquid crystal layer 28 is formed after the first electrodes 16 is made flat by forming the first buried layer 18. A uniform alignment film can therefore be easily formed by means of rubbing. Moreover, the first buried layer 18 and the spacers 22 can be formed at the same time by means of resin imprinting, because they are made of the same material.

Still further, the spacers 22 can be made of a material having a refractive index that satisfies wave-guiding requirements. More precisely, the spacers 22 may be made of a material having a larger refractive index than the material of the liquid crystal layer 28. In this case, stray light never reaches the pixels from the boundary of any pixel blocks. This prevents the mixing of light beams of different colors emitted from the pixel blocks, and ultimately enhances the resolution of the resultant color image.

In the embodiment shown in FIG. 1, the spacers 22 are densely arranged. Nonetheless, the spacers 22 need not be densely arranged so long as they are regularly arranged. Further, the shape of the spacers 22 is not limited to the V-shape. Some modifications of the embodiment will be described, in which the spacers 22 are changed in arrangement and shape.

### [Modification 1]

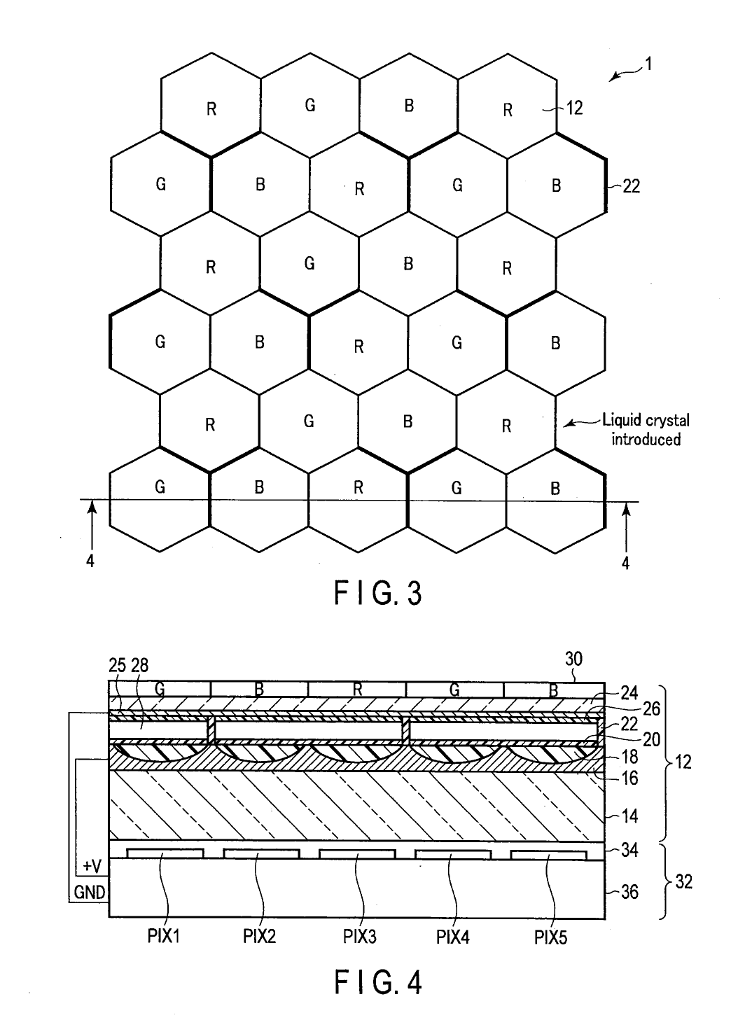

As shown in FIG. 3 and FIG. 4, the spacers 22 are Y-shaped in Modification 1. One Y-shaped spacer 22 is arranged at the boundaries of three delta-arranged pixel blocks. Modification 1 is identical to the above-described embodiment in any other configuration respects. Modification 1 shown in FIG. 3 and FIG. 4 is indeed inferior to the embodiment shown in FIG. 1 and FIG. 2 in terms of strength. However, liquid crystal can be easily introduced into the gap between the first electrode 16 and the second electrode 25. In the embodiment shown in FIG. 1, the liquid crystal layer 28 is sealed by the spacers 22.

Hence, the liquid crystal must be dripped before the first substrate 14 and second substrate 24 are bonded together. In Modification 1, the liquid crystal can be introduced from, for example, any side of the liquid crystal element 12, after the first substrate 14 and second substrate 24 have been bonded together.

Further, a Y-shaped spacer 22 need not be provided for every three pixel blocks in Modification 1. In other words, three adjacent pixel blocks may be spaced apart by a Y-shaped spacer 22, while another three adjacent pixel blocks may not be spaced by a Y-shaped spacer 22.

If the spacers 22 are spaced apart too much, the second substrate 24 will more likely warp. Every three adjacent delta-arranged pixel blocks constitute one pixel-block set. It is desirable to provide one Y-shaped spacer 22 for one to eight pixel-block sets.

### [Modification 2]

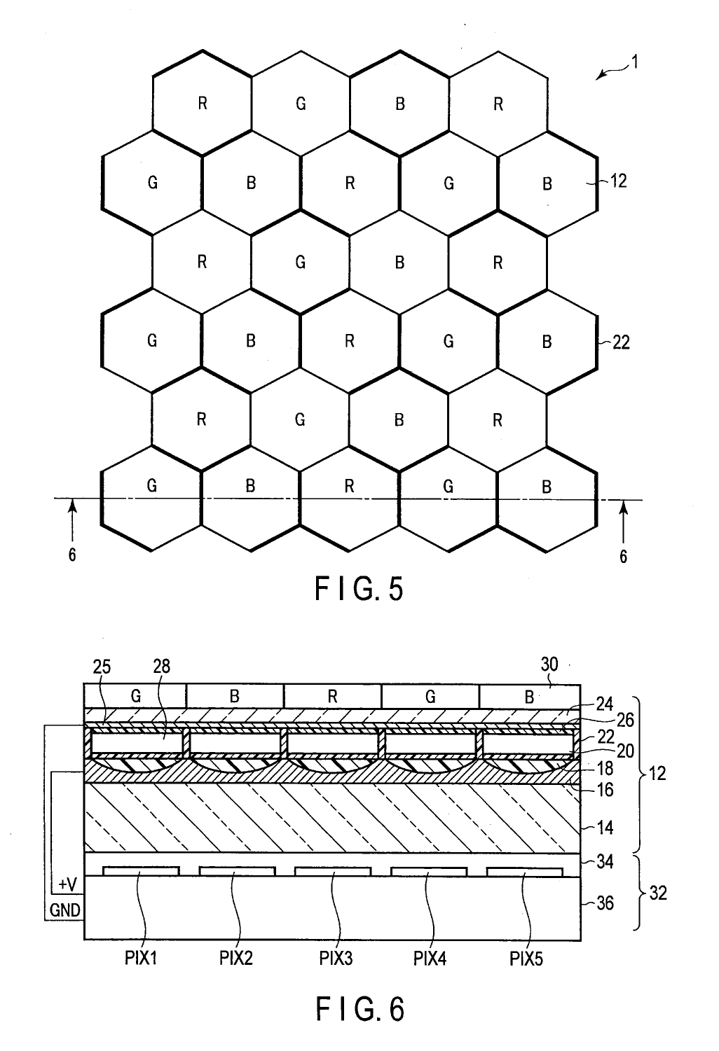

FIG. 5 and FIG. 6 show Modification 2. In Modification 2, spacers 22 are arrange in a specific way. The three pixel blocks constituting one set will be described in detail. A spacer 22 is provided at the boundaries of the three pixel blocks of each set, and opposes the spacer 22 contacting the pixel blocks of another set. The point at which the three pixel blocks contact is connected to a center of one pixel block by a first line. A second line is perpendicular to the first line and passes the center of the pixel block. Each pixel block has a pair of spacers 22 arranged symmetric with respect to the second line. As may be seen from FIG. 5, one pixel block has a pair of V-shaped spacers 22.

That is, the shape of spacers 22 arranged in a two-dimensional array with respect to pixel block sets will be explained below. Points each contacting three pixel blocks are arranged in one line. On this line, the points at which the Y-shaped spacers 22 are arranged and the points at which no Y-shaped spacers 22 are arranged exist alternately. The intersection of three lines defining the letter Y lies at the point where a Y-shaped spacer 22 is arranged. In other words, no spacers 22 are provided for the micro-lenses of any odd-numbered row, and spacers 22 are provided for the micro-lenses of each even-numbered row, each spacer 22 at a position equivalent to the boundary of the micro-lens. In this case, any two adjacent spacers 22 are arranged inversely to each other. Thus, the spacers 22 shaped like a Y and the spacers shaped like an inverted Y are alternately arranged.

In Modification 2 shown in FIG. 5 and FIG. 6, the liquid crystal can be easily introduced as in Modification 1. In addition, the liquid crystal element 12 cab be more strengthened than in Modification 1.

As in Embodiment 1 of FIG. 3 and FIG. 4, the interval at which the spacers 22 are arranged is not limited to the interval shown in FIG. 5 and FIG. 6. The spacers 22 may instead be spaced apart by a distance of two micro-lenses as in Embodiment 1.

### [Modification 3]

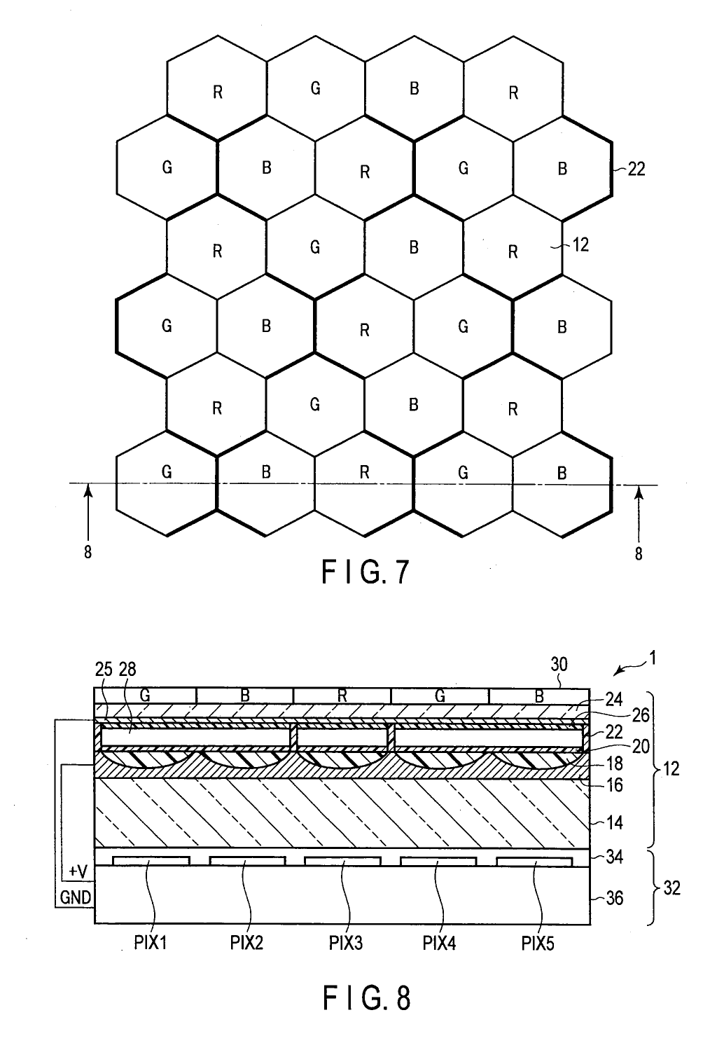

FIGS. 7 and 8 show Modification 3. In Modification 3, no spacers 22 are provided for the micro-lenses of any odd-numbered row, and H-shaped spacers are provided for the micro-lenses of any even-numbered row. In Modification 3, four pixel blocks constitute one set. Of the four pixel blocks of each set, three pixel blocks contact at a first point, and the remaining pixel block and two other pixel blocks contact at a second point. Hence, each pixel-block set includes two pixel blocks that contact both the first point and the second points. If these two pixel blocks are projected to a plane parallel to the major surface of the substrate 14, they will contact on one line. Each spacer 22 has a part that extends along this line, and has two parts that cross this line at the first point. The two parts of the spacer 22 extend along the boundaries of two pixel blocks. The spacer further has two parts intersecting with that line. These two parts extend along the boundaries of the two pixel blocks.

In Embodiment 3 shown in FIG. 7 and FIG. 8, the liquid crystal can be easily introduced as in Modification 1. Further, the liquid crystal element 12 can be more strengthened than in Modification 1.

### [Embodiment 4]

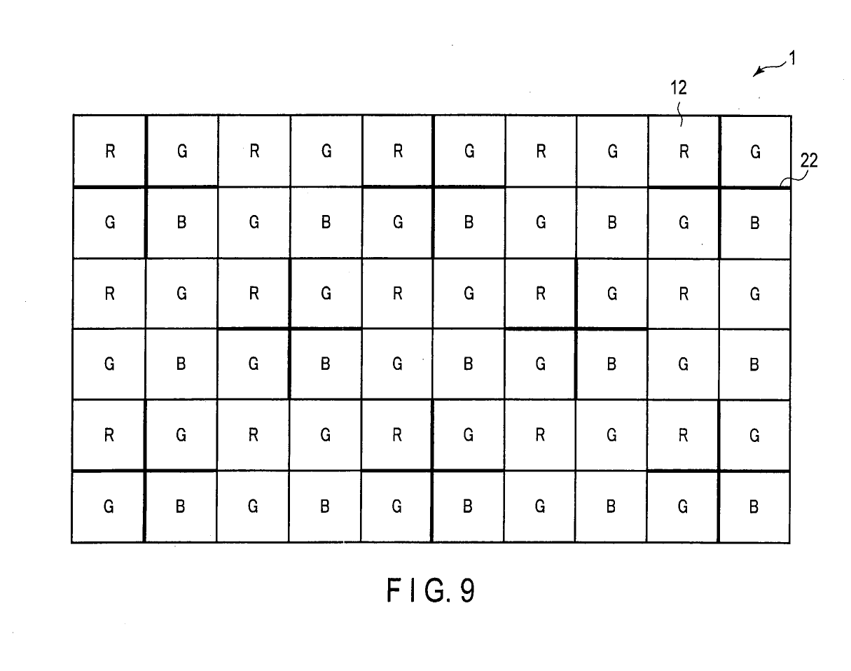

FIG. 9 shows Modification 4. In Modification 4, the micro-lenses are shaped almost like a square. The square-shaped micro-lenses are arranged in square array. By contrast, the color filters 30 are arranged in a mosaic pattern. More precisely, filter units, each composed of R, G and B filter elements, are arranged in a two-dimensional pattern. As shown in FIG. 9, cross-shaped spacers 22 are arrange between the micro-lenses arranged in the square array. Thus, the spacers 22 can be arranged, even if the micro-lenses are not shaped like a hexagon or not delta-arranged.

### [Other Modifications]

In the embodiment and the modification thereof, described above, the first electrode 16 is made flat by forming the first buried layer 18. The first buried layer 18 need not be provided, nevertheless. If this is the case, the first alignment film 20 is formed on the first electrode 16 and has a curved surface.

Further, the first electrode 16 may have a member shaped like a plano-concave lens or a plano-convex lens, and a conductive layer formed on this member. The member shaped like a plano-concave lens or a plano-convex lens may be made of an insulating material or conductive material.

The embodiment and the modifications thereof, all described above, can be used also in any liquid crystal optical element of the ordinary framework type.

In the embodiment and the modifications thereof, all described above, the refractive index of the first buried layer 18 is equal to the refractive index of the spacers 22 and the refractive index of the liquid crystal layer 28 while applied with no voltage. If the first buried layer 18 and the spacers 22 are not made of the same material, the refractive index of the first buried film 18 need not be equal to the refractive index of the spacers 22 and the refractive index of the liquid crystal layer 28 while applied with no voltage. In this case, the spacers 22 may have a refractive index much larger than that of the liquid crystal layer 28. Then, the propagation of stray light from one micro-lens to any adjacent micro-lens can be controlled.

The image apparatus 1 of FIG. 1 is an imaging apparatus. It suffices for the image apparatus 1 to comprise the image unit 32. Hence, the image apparatus 1 may be a display such as liquid crystal display. If the image apparatus 1 is a liquid crystal display, the liquid crystal element 12 is laid on the image unit 32, and the first substrate 14 is thereby exposed outside the image apparatus 1.

While certain embodiments have been described, these embodiments have been presented by way of example only, and are not intended to limit the scope of the inventions.

Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal optical element comprising:
a first electrode including a plurality of lens parts;
a second electrode opposing the first electrode;
a first alignment film formed between the first electrode and the second electrode;
a second alignment film formed between the first alignment film and the second electrode;
spacers provided between the first electrode and the second electrode and regularly arranged, each at edges of the lens parts; and
a liquid crystal layer provided between the first alignment film and the second alignment film.

2. The liquid crystal optical element according to claim 1, further comprising a color filter,
Wherein the second electrode is provided between the second alignment film and the color filter, and the color filter includes a first element, a second element and a third element respectively opposing the lens parts arranged on one major surface.

3. The liquid crystal optical element according to claim 2, wherein the spacers provided at edges of the first, second and third elements are revolution-symmetric to the first, second and third elements, respectively, with respect to one point, and the spacers and the first, second and third elements are projected to the major surface.

4. The liquid crystal optical element according to claim 1, wherein the spacers are shaped like at least one of H-shape, Y-shape, V-shape and cross-shape.

5. The liquid crystal optical element according to claim 1, further comprising a buried layer provided between the first electrode and the first alignment film and filling a recess made in the first electrode.

6. The liquid crystal optical element according to claim 5, wherein the spacers and the buried layer are made of same material.

7. An image apparatus comprising:
a liquid crystal optical element according to claim 1; and
an image unit opposing the liquid crystal optical element,
wherein the imaging unit includes a plurality of pixel blocks opposing the lens parts, respectively.
